(19) United States
(12) Patent Application Publication
(10) Pub. No.: US 2010/0315376 A1
(43) Pub. Date: Dec. 16, 2010

(54) CONTROL INTERFACE ASSEMBLIES AND VEHICLES INCLUDING SAME

(76) Inventor: Dave Jaeyeong Choi, Marysville, OH (US)

Correspondence Address: ULMER & BERNE, LLP;ATTN: DIANE BELL, 600 VINE STREET, SUITE 2800, CINCINNATI, OH, 45202, US

(21) Appl. No.: 12/481,955

(22) Filed: Jun. 10, 2009

(51) Int. Cl. G06F 3/042

(52) U.S. Cl. 345/175

(57) ABSTRACT

A control interface assembly includes a touch sensor panel, a laser assembly, first and second laser detectors, and a controller. The touch sensor panel includes a touch surface extending within a touch plane. The laser assembly emits first and second portions of laser light. At least one of the first and second portions of laser light is directed within a laser plane which is spaced from the touch plane. The first and second laser detectors are positioned to receive the respective first and second portions of laser light. The controller is coupled with each of the touch sensor panel and the first and second laser detectors. The controller is configured to detect engagement of the touch surface by an operator's finger and is further configured to detect passage of an operator's finger through the laser plane. Vehicles including a control interface assembly are also provided.

### TECHNICAL FIELD

The present invention relates to vehicular control interface assemblies.

### BACKGROUND

Some conventional vehicles include graphical user interfaces which facilitate control of various vehicular systems by an operator of the vehicle.

### SUMMARY

In accordance with one embodiment, a control interface assembly comprises a touch sensor panel, a laser assembly, a first laser detector, a second laser detector, and a controller. The touch sensor panel comprises a touch surface which extends within a touch plane. The laser assembly is configured to emit a first portion of laser light and a second portion of laser light. The first portion of laser light is oriented generally perpendicular to the second portion of laser light. At least one of the first portion of laser light and the second portion of laser light is directed within a laser plane. The laser plane is spaced from the touch plane. The first laser detector is positioned to receive the first portion of laser light. The second laser detector is positioned to receive the second portion of laser light. The controller is coupled with each of the touch sensor panel, the first laser detector, and the second laser detector. The controller is configured to detect engagement of the touch surface by an operator's finger and is further configured to detect passage of an operator's finger through the laser plane.

In accordance with another embodiment, a vehicle comprises a control console, a steering interface extending from the control console, a graphical user interface, and a control interface assembly. The control interface assembly comprises a touch sensor panel, a laser assembly, a first laser detector, a second laser detector, and a controller. The touch sensor panel comprises a touch surface which extends within a touch plane. The laser assembly is configured to emit a first portion of laser light and a second portion of laser light. The first portion of laser light is oriented generally perpendicular to the second portion of laser light. At least one of the first portion of laser light and the second portion of laser light is directed within a laser plane. The laser plane is spaced from the touch plane. The first laser detector is positioned to receive the first portion of laser light. The second laser detector is positioned to receive the second portion of laser light. The controller is coupled with each of the touch sensor panel, the first laser detector, the second laser detector, and the graphical user interface. The controller is configured to detect engagement of the touch surface by an operator's finger, detect passage of an operator's finger through the laser plane, and control the graphical user interface in response to the detected engagement and the detected passage. The control interface assembly is attached to one of the control console and the steering interface and is positioned such that an operator's hand can simultaneously contact the steering interface and the touch surface of the touch sensor panel.

In accordance with yet another embodiment, a vehicle comprises a control console, a steering wheel extending from the control console, a graphical user interface, and a control interface assembly. The control interface assembly comprises a touch sensor panel, a laser assembly, a first laser detector, a second laser detector, and a controller. The touch sensor panel comprises a touch surface which extends within a touch plane. The laser assembly is configured to emit a first portion of laser light and a second portion of laser light each extending within a laser plane and having a wavelength between about 380 nm and about 750 nm. The first portion of laser light is oriented generally perpendicular to the second portion of laser light. The laser plane is spaced from and parallel with the touch plane. The first laser detector extends within the laser plane and is positioned to receive the first portion of laser light. The second laser detector extends within the laser plane and is positioned to receive the second portion of laser light. The controller is coupled with each of the touch sensor panel, the first laser detector, the second laser detector, and the graphical user interface. The controller is configured to detect engagement of the touch surface by an operator's finger, detect passage of an operator's finger through the laser plane, and control the graphical user interface in response to the detected engagement and the detected passage. The control interface assembly is attached to one of the control console and the steering wheel and is positioned such that an operator's hand can simultaneously contact the steering wheel and the touch surface of the touch sensor panel.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a left side elevational view depicting a vehicle in accordance with one embodiment;

FIG. 2 is an interior view depicting certain features within a passenger compartment of the vehicle of FIG. 1;

FIG. 3 is a right side view, shown partially in elevation and partially in cross-section, depicting a right hand of an operator grasping a steering wheel while simultaneously interacting with a control interface assembly attached to a control console of the vehicle of FIG. 2, wherein the hand is shown in solid and dashed lines to have first and second respective positions, in which first position an index finger of the hand does not contact a touch surface of the control interface assembly, and in which second position the index finger contacts the touch surface;

FIG. 4 is a perspective view depicting a portion of the control interface assembly of FIGS. 2-3 as removed from the control console;

FIG. 5 is a perspective view depicting a portion of the control interface assembly of FIGS. 2-3 as removed from the control console and in association with an operator's index finger;

FIG. 6 is a block diagram depicting various components of the control interface assembly of FIGS. 2-5 in association with a display screen and a projector of a heads-up display system; and

FIG. 7 is a flowchart depicting a process of operating a graphical user interface through use of the control interface assembly of FIGS. 2-6 in accordance with one embodiment.

### DETAILED DESCRIPTION

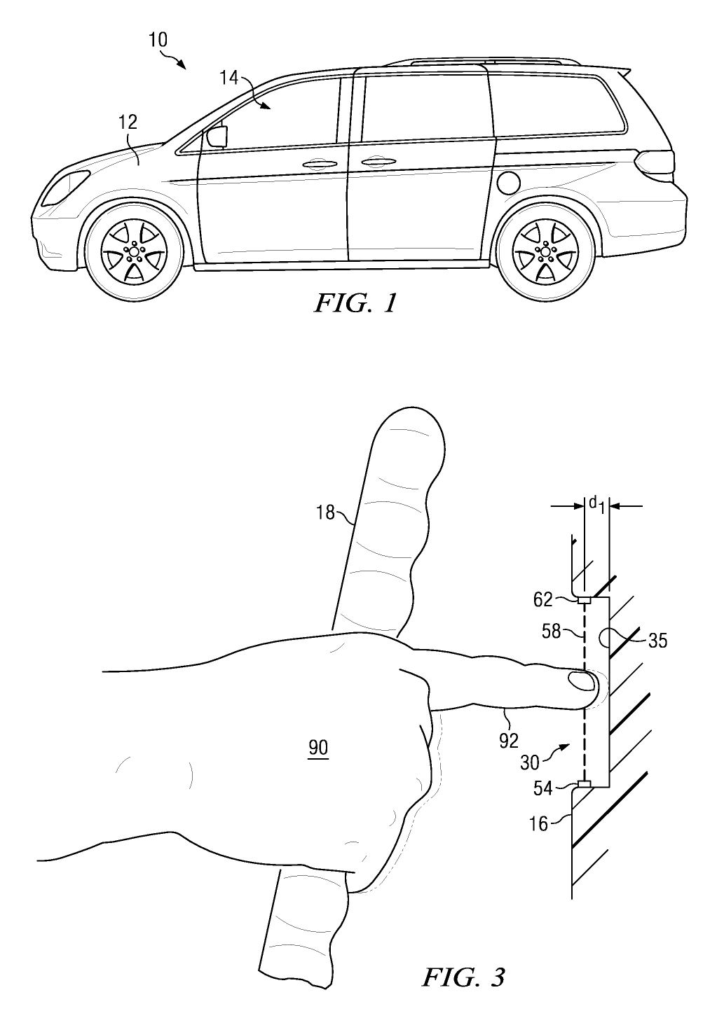

Certain embodiments are hereinafter described in detail in connection with the views and examples of FIGS. 1-7. A control interface assembly as described herein can be provided upon any of a variety of suitable vehicles such as, for example, cars, trucks, vans, watercraft, utility vehicles, recreational vehicles, and aircraft. A control interface assembly can be generally configured for use by an operator of the vehicle to control one or more systems present upon the vehicle, as described in further detail below. For example, a vehicle 10 is shown in FIG. 1 to include a body structure 12. The body structure 12 can include body members and frame members which generally define an outer shell of the vehicle 10, and which at least partially define a passenger compartment 14 of the vehicle 10. Passengers and cargo can reside within the passenger compartment 14 during use of the vehicle 10.

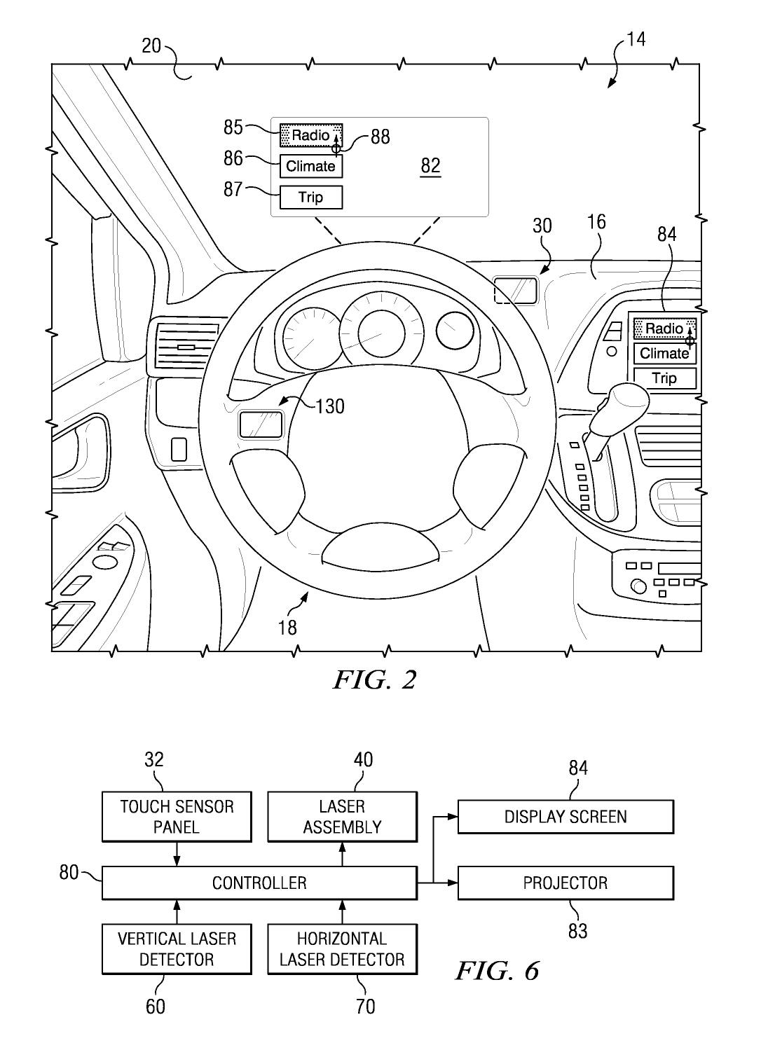

An operator seated within the passenger compartment 14 can facilitate steering of the vehicle 10 through use of a steering wheel 18 or other steering interface, such as shown in FIGS. 2-3. The vehicle 10 can also include a dashboard or control console 16, from which the steering wheel 18 can extend. It will be appreciated that the control console 16 can support indicators and control devices for use by an operator to facilitate control of the vehicle 10. For example, a control interface assembly 30 is shown in FIGS. 2-3 to be attached to the control console 16. The control interface assembly 30 can be used by an operator in conjunction with a remote graphical user interface to facilitate control of one or more systems present upon the vehicle 10, as described in further detail below. In one embodiment, the graphical user interface can comprise a display screen 84 attached to the control console 16, as shown in FIG. 2. In another embodiment, the graphical user interface can additionally or alternatively comprise a heads-up display 82 which is projected upon a windshield 20 of the vehicle 10 by a projector (83 shown in FIG. 6) attached to the control console 16 or another part of the vehicle 10.

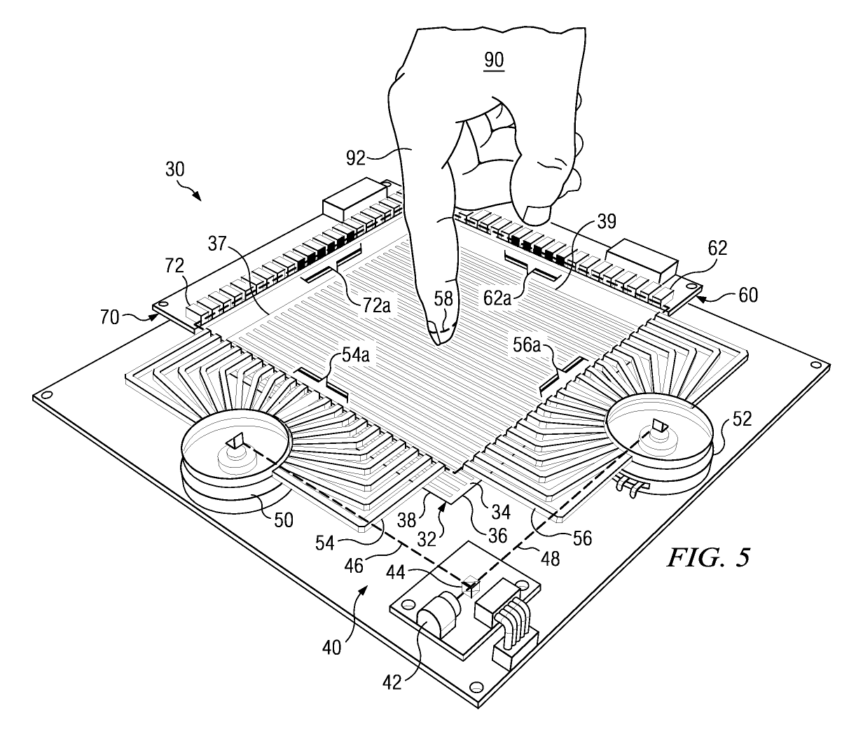

The control interface assembly 30 can be configured for interaction with one or more fingers of an operator's hand, as generally shown in FIGS. 3 and 5, to facilitate manipulation by an operator of cursors, icons, and other features provided upon the graphical user interface, and resultant control of associated vehicular systems. Such systems can include, for example, a radio, a climate control system, a trip computer, seat and mirror position controls, a global positioning system (“GPS”), a telephone, and vehicle diagnostics. Accordingly, by interacting with the control interface assembly 30, and thus with the graphical user interface, an operator can control one or more such vehicular systems. It will be appreciated that such an arrangement can provide an intuitive control system which affords an operator of the vehicle 10 with the immediacy and dexterity of a computer mouse or a console-mounted joystick or roller-ball control device, but without requiring the operator to remove his or her hands from the steering wheel 18.

A control interface assembly 30 can have any of a variety of suitable configurations. In one embodiment, such as shown in FIGS. 2-6, a control interface assembly 30 can include a touch sensor panel 32. The touch sensor panel 32 comprises a touch surface 34 which can extend within a touch plane (identified as 35 in FIG. 3) between respective vertical edges 36, 37 and horizontal edges 38, 39. The touch surface 34 of the touch sensor panel 32 can be configured to be contacted by a finger 92 of an operator's hand 90, as shown in FIGS. 3 and 5. The touch sensor panel 32 can include any of a variety of suitable touch sensing components including, for example, capacitive detectors, inductive detectors, and conductive detectors.

The control interface assembly 30 can also include a laser assembly 40. The laser assembly 40 can be configured to emit laser light within one or more laser planes (e.g., 58) which can be spaced from the touch plane 35. The laser plane 58 can be spaced from the touch plane 35 by a distance d₁ as shown in FIG. 3. In one embodiment, the laser plane 58 can be spaced from the touch plane 35 by a distance of at least about 6 mm. In another embodiment, the laser plane 58 can be spaced from the touch plane 35 by a distance of between about 6 mm and about 12 mm. In yet another embodiment, the laser plane 58 can be spaced from the touch plane 35 by a distance of between about 12 mm and about 24 mm. In still another embodiment, the laser plane 58 can be spaced from the touch plane 35 by a distance of at least about 24 mm. In such a configuration, the finger 92 of an operator's hand 90 can pass through the laser plane 58 when contacting the touch surface 34, but the distance d₁ can be sufficiently large such that an operator can freely wave the finger 92 within the laser plane 58 without inadvertently contacting the touch surface 34.

In one embodiment, as shown in the example of FIGS. 3-5, the laser plane 58 can be parallel with the touch plane 35. In another embodiment, as also shown in the example of FIGS. 3-5, the laser plane 58 can be generally co-extensive with the touch plane 35. It will be appreciated that, in other embodiments, a laser plane might not be parallel and/or generally co-extensive with a touch plane. Also, though the control interface assembly 30 is shown in the example of FIGS. 3-5 to include only a single laser plane (i.e., 58) it will be appreciated that an alternative control interface assembly can include multiple distinct laser planes.

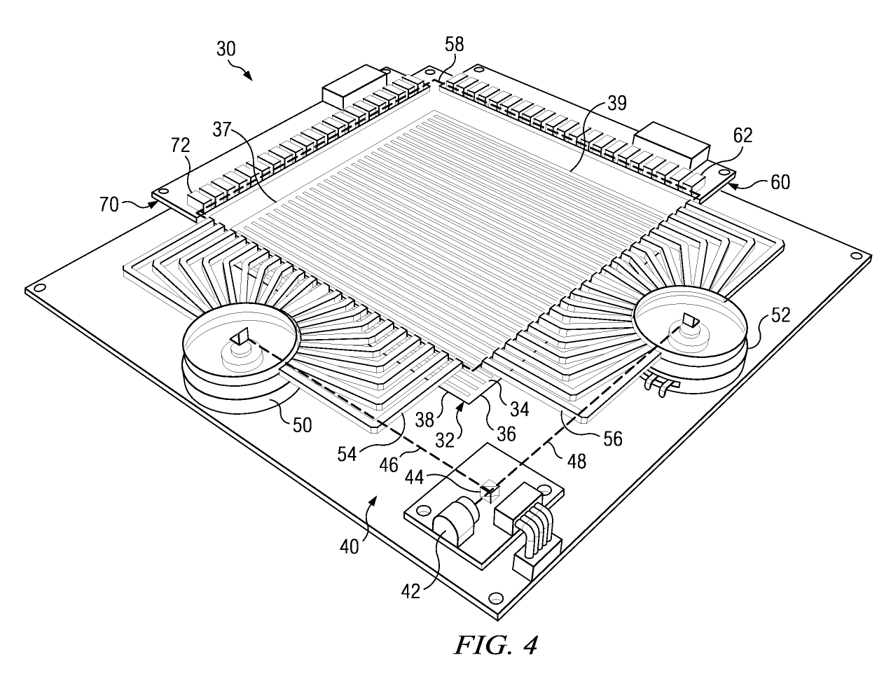

A laser assembly can be provided in any of a variety of suitable configurations. In one example, as shown in FIGS. 3-5, the laser assembly 40 can include a laser diode 42 which is configured to emit laser light. The laser assembly 40 can also include a splitter 44 which is configured to receive the laser light from the laser diode 40. The splitter 44 can divide the laser light into first and second portions of laser light 46, 48 as shown in dashed lines in FIGS. 4-5. The splitter 44 can direct the first portion of laser light 46 to a movable reflective device 50, and can direct the second portion of laser light 48 to another movable reflective device 52. The movable reflective device 50 can be configured to emit the first portion of laser light 46 such that the first portion of laser light 46 is vertically directed and distributed within the laser plane 58. Likewise, the movable reflective device 52 can be configured to emit the second portion of laser light 48 such that the second portion of laser light 48 is horizontally directed and distributed within the laser plane 58. In one embodiment, as shown generally in FIGS. 4-5, a portion of the movable reflective device 52 can be in correspondence with the vertical edge 36 of the touch surface 34, while a portion of the movable reflective device 50 can be in correspondence with the horizontal edge 38 of the touch surface 34. While each of the first and second portions of laser light 46 and 48 can be directed within the common laser plane 58 as shown in the embodiment of FIGS. 3-5, it will be appreciated that respective portions of laser light emitted by a laser assembly (e.g., directed vertically and horizontally) can extend within different laser planes.

In one embodiment, each of the movable reflective devices 50 and 52 can comprise a respective motorized reflector, one or more MEMS mirrors, and/or any of a variety of other suitable devices. In order to facilitate distribution of light within the laser plane 58, the movable reflective devices 50 and 52 can include a plurality of respective light guides (e.g., 54, 56) which are shown to be arranged in respective lines. In this configuration, the laser assembly 40 can comprise a sweeping laser in that light from the laser diode 42 is swept across the laser plane 58 through use of the splitter 44 and the movable reflective devices 50 and 52. In an alternative embodiment, it will be appreciated that a laser assembly might not include a single laser diode, but might rather include two separate laser diodes configured to create respective horizontal and vertical fields or otherwise perpendicular fields of laser light. In still another embodiment, a laser assembly might not include movable reflective devices, but might rather include an array of laser diodes arranged in a straight line and configured to produce a laser plane. In yet a further alternative embodiment, a laser assembly might not include any laser diode(s), but might rather include any of a variety of other suitable types of laser.

The control interface assembly 30 can also include first and second laser detectors 60 and 70, as shown in FIGS. 3-5. The first laser detector 60 can be positioned to receive the first portion of laser light 46 from the light guides (e.g., 54) associated with the movable reflective device 50. Likewise, the second laser detector 70 can be positioned to receive the second portion of laser light 48 from the light guides (e.g., 56) associated with the movable reflective device 52. In the configuration of FIGS. 3-5, the first and second portions of laser light 46, 48 are generally perpendicular to one another and extend within the laser plane 58. In one embodiment, as shown in the example of FIGS. 3-5, the first laser detector 60 can include a plurality of detector units (e.g., 62) arranged in a line as an array, while the second laser detector 70 can include a plurality of detector units (e.g., 72) arranged in a line as an array. Each of the respective detector units (e.g., 62, 72) can be aligned with and generally configured to receive light from a respective one of the light guides (e.g., 54, 56). In an alternative embodiment, instead of an array of detector units, a laser detector can comprise any of a variety of other suitable detection arrangements such as, for example, a vertically or horizontally extending charge coupled device (“CCD”). In one embodiment, as shown in FIGS. 4-5, the first laser detector 60 can be in correspondence with the horizontal edge 39 of the touch surface 34, while the second laser detector 70 can be in correspondence with the vertical edge 37 of the touch surface 34.

In one embodiment, the laser diode 42, and thus the laser assembly 40, can be configured to produce the first and second portions of laser light 46 and 48 such that they have a wavelength in the visible spectrum, or between about 380 nm and 750 nm. In such a configuration, an operator can see the laser light hit his or her finger when the finger penetrates the laser plane 58, as shown generally in FIG. 5. Whatever wavelength the laser assembly 40 is configured to produce, the first and second laser detectors 60 and 70 can be matched to that wavelength, such that the first and second laser detectors 60 and 70 can detect only a narrow bandwidth of light which includes that produced by the laser assembly 40, but can effectively filter or ignore other light sources (e.g., ambient sunlight, dome lights, headlight and streetlight reflections). Use of laser light in this application provides significant benefits as compared to use of non-laser light, as laser light has a very specific wavelength, can be directed without significant diffusion, and can be swept at a well defined and consistent frequency. In such circumstance as when the laser assembly 40 causes laser light to be swept (such as through use of movable reflective devices 50 and 52), the first and second laser detectors 60 and 70 can be configured to expect the particular frequency of the swept laser light and can, in one embodiment, be set slightly off-phase to compensate for the sweeping of the laser light from the laser assembly 40.

Referring now to FIG. 6, the control interface assembly 30 can also include a controller 80. The controller 80 can be coupled with each of the touch sensor panel 32, the laser assembly 40, the first laser detector 60, the second laser detector 70, and a graphical user interface (e.g., the display screen 84 and/or the projector 83). The controller 80 can be configured to detect engagement of the touch surface 34 by an operator's finger 92. The controller 80 can be further configured to detect passage of the operator's finger 92 through the laser plane 58. The controller 80 can then control the graphical user interface in response to the detected engagement of the touch surface 34 by the finger 92 and the detected passage of the finger 92 through the laser plane 58.

The control interface assembly 30 is shown in FIGS. 2-3 as being attached to the control console 16 such that an operator's hand 90 can simultaneously contact the steering wheel 18 and the touch surface 34 of the touch sensor panel 32. In an alternative embodiment, a control interface assembly 130, as shown in FIG. 2, can be attached to the steering wheel 18 such that an operator's hand can simultaneously contact the steering wheel 18 and a touch surface of a touch sensor panel of the control interface assembly 130. It will be appreciated that, other than with respect to its attachment to the steering wheel 18 as opposed to the control console 16, the structure and capabilities of the control interface assembly 130 can be substantially similar to those described herein with respect to the control interface assembly 30. It will also be appreciated that, while both the control interface assembly 30 and the control interface assembly 130 are illustrated as being provided in the embodiment of FIG. 2, a vehicle in accordance with another embodiment might only include a single one of these two control interface assemblies 30, 130, or might additionally or alternatively include an alternatively located and/or configured control interface assembly. By facilitating simultaneous contact by an operator's hand with both the steering wheel 18 and the touch surface 34 of the control interface assembly 30, it will be appreciated that an operator of the vehicle 10 can interact with the control interface assembly 30 without removing his or her hands from the steering wheel 18, and without resulting in any significant distraction to the operator. It will also be appreciated that the control interface assembly 30 can be sufficiently spaced apart from the steering wheel 18, as generally shown in FIG. 3, such that knuckles of an operator's hand are unlikely to inadvertently contact the control interface assembly 30 during steering of the vehicle 10.

When an operator penetrates the laser plane 58 with his or her finger 92, as shown in FIGS. 3 and 5, a portion of the laser plane 58 is broken by the finger 92, and portions of the first laser detector 60 and the second laser detector 70 do not receive laser light from the laser assembly 40. In particular, as best shown in the embodiment of FIG. 5, light from respective ones of the light guides (identified as 54a) is blocked by the finger 92 from reaching respective ones of the detector units (identified as 62a) of the first laser detector 60. The detector units 62a are accordingly shown to be darkened, while passage of laser light to the other ones of the detector units (e.g., 62) of the first laser detector 60 is not shown in FIG. 5 to be blocked. Likewise, light from respective ones of the light guides (identified as 56a) is blocked by the finger 92 from reaching respective ones of the detector units (identified as 72a) of the second laser detector 70. The detector units 72a are accordingly shown to be darkened, while passage of laser light to the other ones of the detector units (e.g., 72) of the second laser detector 70 is not shown in FIG. 5 to be blocked. When the finger 92 is removed and the laser plane 58 is unobstructed, as shown in FIG. 4, laser light from each of the light guides reaches the corresponding ones of the detector units 62 and 72.

By monitoring which of the detector units 62, 72 receives and does not receive laser light, the controller 80 can identify when the laser plane 58 is broken (e.g., by the finger 92), and the precise location at which the laser plane 58 is broken. As a result of this detection, the controller 80 can facilitate movement of a cursor 88 upon a corresponding graphical user interface as shown in FIG. 2. In the example of FIG. 2, an operator can move his or her finger 92 within the laser plane 58 to effect movement of the cursor 88 within the heads-up display 82 and/or the display screen 84. In one example, movement of the cursor 88 can be in one-to-one correspondence with movement of an operator's finger within the laser plane 58.

Through use of the control interface assembly 30, the cursor 88 can be moved atop one or more icons present within the graphical user interface such as, for example, are shown in FIG. 2 to comprise a “Radio” icon 85, a “Climate” icon 86, and a “Trip” icon 87. When the cursor is moved atop a particular icon, the icon can become highlighted, such as shown for example by the “Radio” icon or button in FIG. 2. An operator can then extend his or her finger 92 to contact the touch surface 34 of the touch sensor panel 32 in order to facilitate selection of the highlighted icon. Once the highlighted icon is selected in this manner, a submenu or different grouping of icons can appear upon the graphical user interface, and the control interface assembly 30 can be used by the operator in a similar manner to select from among the new icons. In addition to facilitating selection of icons present upon a graphical user interface, it will be appreciated that the control interface assembly 30 can also facilitate dragging and dropping of icons, and/or other forms of icon manipulation or management.

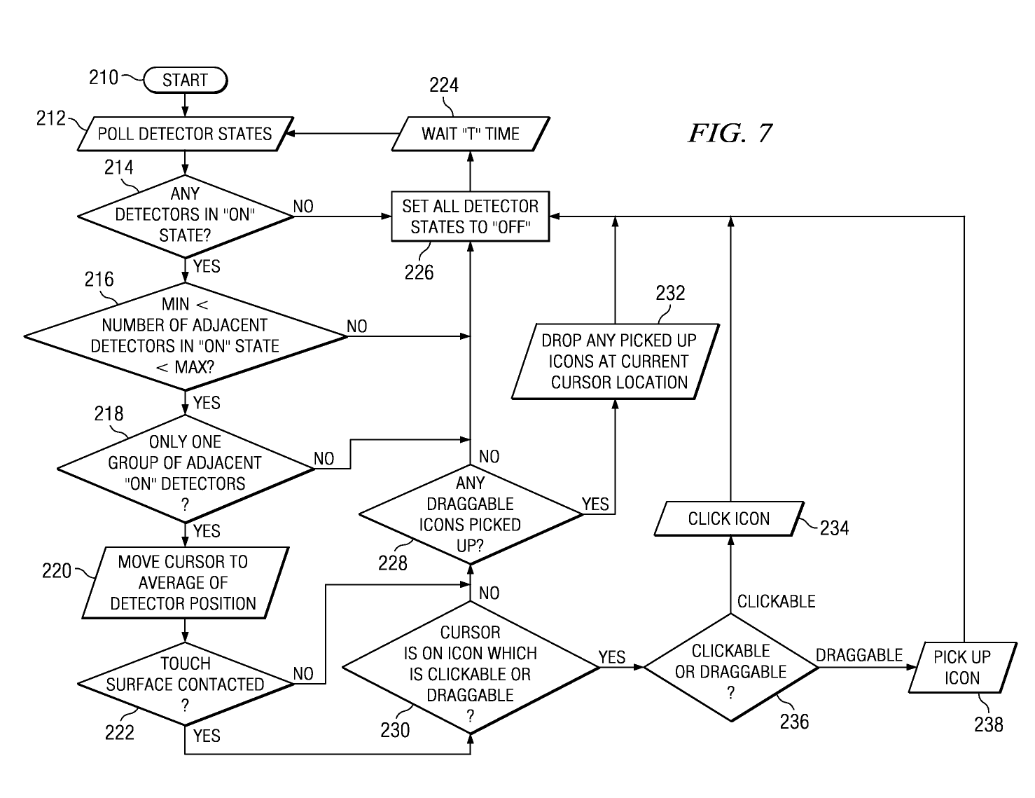

FIG. 7 is a flowchart depicting one manner in which a control interface assembly 30 can interact with a graphical user interface in response to interaction by an operator. Starting at block 210, the controller 80 can poll the states of the first and second laser detectors 60 and 70, shown generally at block 212. The controller 80 can determine whether any of the detector units (e.g., 62, 72) of the first and second laser detectors 60 and 70 are in an “ON” state, as shown at block 214. The “ON” state corresponds with a particular detector unit (e.g., 62, 72) not receiving laser light. If the “ON” state is not detected, the controller 80 registers this information (shown at block 226), waits a predetermined period of time (block 224), and then repeats the detector polling process (block 212). In one example, when polling the first and second laser detectors 60 and 70, each of the individual detector units (e.g., 62, 72) can be polled over a given time length interval to assess whether the particular detector unit had received a laser impulse within the last polling period. When any of the detector units (e.g., 62, 72) are found to be in the “ON” state (i.e., meaning that they do not receive laser light), the states of the individual detector units (e.g., 62, 72) can be stored in a matrix (e.g., by the controller 80) and, such as through use of the process shown in FIG. 7, the controller 80 can move or maintain the cursor 88 from or in its current position.

If the “ON” state is detected, the controller 80 determines whether the blockage in the laser plane 58 is too small or too large than would typically correspond with an operator's finger, such as by assessing whether too few or too many of the detector units (e.g., 62, 72) are not receiving laser light (see block 216). If the controller 80 determines the blockage to be too small or too large, the controller 80 can register that all detector units are “OFF” (shown at block 226), wait a predetermined period of time (block 224), and then repeat the detector polling process (block 212). If the controller 80 determines that the blockage is of an acceptable size to correspond with the finger of an operator, the controller 80 can then determine whether there is only one single blockage in the laser plane 58 (i.e., that only one finger passes through the laser plane 58), and such as by assessing whether all detector units (e.g., 62, 72) in an “ON” state (i.e., not receiving laser light) of each of the respective first and second laser detectors 60 and 70 are adjacent to one another (block 218). If the controller 80 determines that non-adjacent groups of detector units of one or both of the first and second laser detectors 60 and 70 are not receiving laser light, the controller 80 can register that all detector units are “OFF” (shown at block 226), wait a predetermined period of time (block 224), and then repeat the detector polling process (block 212). However, if the controller 80 determines that only an adjacent group of detector units (e.g., 62) of the first laser detector 60 is not receiving laser light, and only an adjacent group of detector units (e.g., 72) of the second laser detector 70 is not receiving laser light, the controller 80 can then effect movement of the cursor 88 to a corresponding average position on the graphical user interface (block 220) and can begin monitoring the touch surface 34 for contact by an operator's finger (block 222). For example, with reference to FIG. 5, if five detector units 62a of the first laser detector 60 and six detector units 72a of the second laser detector 70 do not receive laser light as a result of the finger 92 breaking the laser plane 58, it will be appreciated that the cursor 88 can be positioned within the graphical user interface at a horizontal position generally corresponding to the horizontal position of the center one of the detector units 62a, and at a vertical position generally corresponding to the vertical position of the center one of the detector units 72a.

If, at that point (i.e., block 222), the controller 80 determines that the touch surface 34 is being contacted, the controller 80 can determine whether any icon on which the cursor 88 sits is clickable or draggable (block 230). If the controller 80 determines that the icon is not clickable or draggable, the controller 80 can then determine whether any icons have already been picked up by the cursor 88 and are accordingly in process of being dragged within the graphical user interface (block 228). However, if the controller 80 determines (at block 222) that the touch surface 34 is not being contacted, the controller 80 can move directly to determining (at block 228) whether any icons have already been picked up by the cursor 88 and are accordingly in process of being dragged within the graphical user interface (block 228). If icons are not in the process of being so dragged, the controller 80 can register that all detector units are “OFF” (shown at block 226), wait a predetermined period of time (block 224), and then repeat the detector polling process (block 212). If icons are in the process of being so dragged, the controller 80 can then cause those icons to be dropped at their current location (block 232), the controller 80 can register that all detector units are “OFF” (shown at block 226), wait a predetermined period of time (block 224), and then repeat the detector polling process (block 212).

If the controller 80 determines that the touch surface 34 is being contacted (block 222) and the icon on which the cursor 88 sits is clickable or draggable (block 230), the controller 80 can then determine whether the icon is either clickable or draggable (step 236). If clickable, the controller 80 can cause the icon to be clicked (block 234), such as shown by the highlighted “Radio” icon in FIG. 2, and can then register that all detector units are “OFF” (shown at block 226), wait a predetermined period of time (block 224), and then repeat the detector polling process (block 212). If draggable, the controller 80 can cause the icon to be picked up (block 238), and can then register that all detector units are “OFF” (shown at block 226), wait a predetermined period of time (block 224), and then repeat the detector polling process (block 212). The touch surface 34 can accordingly be activated or monitored (block 222) when the location of the cursor 88 within the graphical user interface coincides with a clickable icon (e.g., the “Radio” icon 85). The touch surface 34 can also be activated or monitored (block 222) when the location of the cursor 88 within the graphical user interface coincides with a draggable icon (such as a map on a GPS display screen), and the draggable icon can be moved in accordance with movement of the cursor 88 until the touch sensor 34 is no longer being contacted by an operator's finger, at which location the draggable item will be dropped. Accordingly, the control interface assembly 30 can facilitate mousing, clicking, and dragging of the cursor 88 by an operator. It will be appreciated that a controller 80 of a control interface assembly 30 can implement any of a variety of suitable variations of the process shown in FIG. 7 and described herein.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A control interface assembly comprising:
a touch sensor panel comprising a touch surface, the touch surface extending within a touch plane;
a laser assembly configured to emit a first portion of laser light and a second portion of laser light, the first portion of laser light being oriented generally perpendicular to the second portion of laser light, at least one of the first portion of laser light and the second portion of laser light being directed within a laser plane, the laser plane being spaced from the touch plane;
a first laser detector positioned to receive the first portion of laser light;
a second laser detector positioned to receive the second portion of laser light; and
a controller coupled with each of the touch sensor panel, the first laser detector, and the second laser detector, the controller being configured to detect engagement of the touch surface by an operator's finger and being further configured to detect passage of an operator's finger through the laser plane.

2. The control interface assembly of claim 1 wherein:
the first laser detector comprises a plurality of first detector units arranged in a first line; and
the second laser detector comprises a plurality of second detector units arranged in a second line.

3. The control interface assembly of claim 2 wherein each of the first portion of laser light and the second portion of laser light has a wavelength matched to that of each of the first detector units and the second detector units.

4. The control interface assembly of claim 3 wherein the wavelength is between about 380 nm and about 750 nm.

5. The control interface assembly of claim 1 wherein the laser plane is spaced from the touch plane by a distance of at least about 6 mm.

6. The control interface assembly of claim 1 wherein the laser assembly comprises:
a first movable reflective device configured to emit the first portion of laser light; and
a second movable reflective device configured to emit the second portion of laser light.

7. The control interface assembly of claim 6 wherein the laser assembly further comprises:
a laser diode configured to emit laser light; and
a splitter configured to receive the laser light from the laser diode, divide the laser light into the first portion of laser light and the second portion of laser light, direct the first portion of laser light to the first movable reflective device, and direct the second portion of laser light to the second movable reflective device.

8. The control interface assembly of claim 6 wherein:
the touch surface extends within the touch plane between respective first and second vertical edges and first and second horizontal edges;
a portion of the first movable reflective device is in correspondence with the first vertical edge of the touch surface;
a portion of the second movable reflective device is in correspondence with the first horizontal edge of the touch surface;
the first laser detector is in correspondence with the second horizontal edge of the touch surface; and
the second laser detector is in correspondence with the second vertical edge of the touch surface.

9. The control interface assembly of claim 1 wherein the touch plane is generally co-extensive with the laser plane.

10. The control interface assembly of claim 1 wherein the laser plane is parallel with the touch plane.

11. The control interface assembly of claim 1 wherein each of the first portion of laser light and the second portion of laser light is directed within the laser plane.

12. A vehicle comprising:
a control console;
a steering interface extending from the control console;
a graphical user interface;
a control interface assembly comprising:
a touch sensor panel comprising a touch surface, the touch surface extending within a touch plane;
a laser assembly configured to emit a first portion of laser light and a second portion of laser light, the first portion of laser light being oriented generally perpendicular to the second portion of laser light, at least one of the first portion of laser light and the second portion of laser light being directed within a laser plane, the laser plane being spaced from the touch plane;
a first laser detector positioned to receive the first portion of laser light;
a second laser detector positioned to receive the second portion of laser light; and
a controller coupled with each of the touch sensor panel, the first laser detector, the second laser detector, and the graphical user interface, the controller being configured to:
detect engagement of the touch surface by an operator's finger;
detect passage of an operator's finger through the laser plane; and
control the graphical user interface in response to the detected engagement and the detected passage;
wherein the control interface assembly is attached to one of the control console and the steering interface and is positioned such that an operator's hand can simultaneously contact the steering interface and the touch surface of the touch sensor panel.

13. The vehicle of claim 12 wherein the steering interface comprises a steering wheel.

14. The vehicle of claim 12 wherein the graphical user interface comprises at least one of a heads-up display system and a display screen.

15. The vehicle of claim 12 wherein:
the first laser detector comprises a plurality of first detector units arranged in a first line;
the second laser detector comprises a plurality of second detector units arranged in a second line; and
each of the first portion of laser light and the second portion of laser light has a wavelength matched to that of each of the first detector units and the second detector units.

16. The vehicle of claim 15 wherein the wavelength is between about 380 nm and about 750 nm.

17. The vehicle of claim 12 wherein the laser plane is spaced from the touch plane by a distance of at least about 6 mm.

18. The vehicle of claim 12 wherein the laser assembly comprises:
a laser diode configured to emit laser light;
a first movable reflective device configured to emit the first portion of laser light;
a second movable reflective device configured to emit the second portion of laser light; and
a splitter configured to receive the laser light from the laser diode, divide the laser light into the first portion of laser light and the second portion of laser light, direct the first portion of laser light to the first movable reflective device, and direct the second portion of laser light to the second movable reflective device.

19. The vehicle of claim 12 wherein the laser plane is parallel with the touch plane.

20. The vehicle of claim 12 wherein each of the first portion of laser light and the second portion of laser light is directed within the laser plane.

21. A vehicle comprising:
a control console;
a steering wheel extending from the control console;
a graphical user interface; and
a control interface assembly comprising:
a touch sensor panel comprising a touch surface, the touch surface extending within a touch plane;
a laser assembly configured to emit a first portion of laser light and a second portion of laser light each extending within a laser plane and having a wavelength between about 380 nm and about 750 nm, the first portion of laser light being oriented generally perpendicular to the second portion of laser light, and the laser plane being spaced from and parallel with the touch plane;
a first laser detector extending within the laser plane and being positioned to receive the first portion of laser light;
a second laser detector extending within the laser plane and being positioned to receive the second portion of laser light; and
a controller coupled with each of the touch sensor panel, the first laser detector, the second laser detector, and the graphical user interface, the controller being configured to:
detect engagement of the touch surface by an operator's finger;
detect passage of an operator's finger through the laser plane; and
control the graphical user interface in response to the detected engagement and the detected passage;
wherein the control interface assembly is attached to one of the control console and the steering wheel and is positioned such that an operator's hand can simultaneously contact the steering wheel and the touch surface of the touch sensor panel.

22. The vehicle of claim 21 wherein the laser plane is spaced from the touch plane by a distance of at least about 6 mm.

23. The vehicle of claim 21 wherein the laser assembly comprises:
a laser diode configured to emit laser light;
a first movable reflective device configured to emit the first portion of laser light;
a second movable reflective device configured to emit the second portion of laser light; and
a splitter configured to receive the laser light from the laser diode, divide the laser light into the first portion of laser light and the second portion of laser light, direct the first portion of laser light to the first movable reflective device, and direct the second portion of laser light to the second movable reflective device; wherein:
the first laser detector comprises a plurality of first detector units arranged in a first line;
the second laser detector comprises a plurality of second detector units arranged in a second line; and
each of the first portion of laser light and the second portion of laser light has a wavelength matched to that of each of the first detector units and the second detector units.
